(19) United States
(12) Patent Application Publication
(10) Pub. No.: US 2019/0109661 A1
(43) Pub. Date: Apr. 11, 2019

(54) Interference Mitigation in Radio Frequencies Communication Systems

(71) Applicant: Skyriver Communications, Inc., San Diego, CA (US)

(72) Inventors: Saeid Safavi, San Diego, CA (US); Saeed Sarikhani Khorami, Carlsbad, CA (US)

(21) Appl. No.: 15/730,070

(22) Filed: Oct. 11, 2017

(51) Int. Cl. H04J 11/00; H04W 72/08; H04W 24/10

(52) U.S. Cl. CPC H04J 11/0023; H04W 24/10; H04W 72/082

(57) ABSTRACT

A communication device includes statistical analysis module and interference mitigation circuitry. In some embodiments, statistical analysis module is configured to receive a set of standards-based channel information (SCI), such as a set of beamforming reports taken for a set of spatial streams, or a set of subscriber unit air quality information. The received SCI correspond to subscriber unit(s) in communication with a base station and operate at radio frequencies such as millimeter waves above 30 GHz. The statistical analysis module is configured to determine, from the received SCI, if communication between the base station and subscriber unit(s) is affected by interference, and determining the source and location of communication interference. The interference mitigation circuitry is configured to mitigate the effect of an interference determined by the statistical analysis module, such as by rescheduling the communication, or re-routing the communication through a different base station or subscriber unit.

### BACKGROUND

### (1) Technical Field

The disclosed methods and apparatus relate to radio frequency communications systems and more particularly to mitigating the effects of interferences in a millimeter wave communication system.

### (2) Background

As the use of wireless communications continues to increase, substantial progress is being made to formulate standards that govern protocols for the manner in which such communications occur. These standards are relevant to several types of communications systems, including cellular telephony, point to point communications, point to multipoint communications, short-range communications, and long-range communications using smaller cells (e.g., picocells and femto cells). Some of the industry standards, such as 802.11ax, contemplate using multiple input, multiple output (MIMO) technology to assist in increasing the system capacity and contemplate the possibility of providing service over longer ranges than the current 802.11 WiFi systems provide. In addition, a 5G communications standard is evolving to consider use of millimeter wavelength signals, such as at frequencies in the range of 30-300 GHz. The use of smaller cells can increase the overall system capacity by allowing greater frequency reuse. In addition, providing base station sectors that are divided into subsectors further enhances the ability to increase capacity through even greater frequency reuse. The use of such advanced techniques and high frequencies pose significant challenges, such as in establishing an architecture that can support higher frequencies and provide efficient, cost effective practical solutions to rolling out such a system on a large scale. Meeting these challenges requires substantial planning and product development.

Already contemplated by Skyriver, a leading-edge millimeter wave (mmWave) broadband provider transforming broadband, are systems that use concepts developed for use in short range 802.11n and 802.11ac compliant systems, together with mmWave transceivers. But while the concepts used in 802.11 systems have advanced, additional advances in conforming products and systems are necessary to take full advantage of some of the new features provided in the newest forms of 802.11, such as 802.11ax. As design and implementation of next generation networks operating in mmWave frequencies is growing, specific attention should be paid to inter-cell and intra-cell interference Therefore, there is currently a need to improve detection and mitigation of interferences affecting communication at microwave frequencies between base stations and subscriber units attempting to communicate with the base stations.

### SUMMARY

The disclosed method and apparatus provides an architecture that mitigates effects of interferences in radio frequency communication systems. In general, such systems have one or more base stations. Each base station is responsible for communicating with several subscriber units.

In some embodiments, a communication device includes a statistical analysis module and interference mitigation circuitry, one or both of which may reside in a base-station and/or in a subscriber unit. The statistical analysis module is configured to receive a set of standards-based channel information (SCI) that is currently in use for other 802.11 purposes, such as a set of beamforming reports taken for a set of spatial streams, or a set of subscriber unit air quality information (e.g. as described in IEEE 802.11k standards). The received SCI corresponds to one or more subscriber units that are in communication with a base station and that operate at radio frequencies, such as millimeter waves around and above 30 GHz. The statistical analysis module is further configured to determine, from the received SCI, if communication between the base station and at least one subscriber unit is affected by interference, and in some embodiments to determine the source and location of communication interference. The interference mitigation circuitry is configured to mitigate the effects of an interference determined by the statistical analysis module, such as by rescheduling the communication to a later time, or re-routing the communication through a different base station, a different subscriber unit or a combination of different base stations and subscriber units.

In some embodiments, the rescheduling or re-routing can also be determined by a central scheduler/re-router, and the re-routing may redirect the path through a different base station, a different subscriber unit or a combination of different base stations and subscriber units, using antenna beamforming techniques. In at least some embodiments, the information is attained from several sources (i.e., base stations and/or subscriber units) and used together to determine the location and nature of the interferer.

The details, features, objects, and advantages of one or more embodiments of the disclosed method and apparatus are set forth in (or contemplated to be apparent from) the accompanying drawings, the description and claims below.

### DESCRIPTION OF THE DRAWINGS

FIG. 1 is an illustration of a base station site and several (subscriber units within a millimeter wave (mmWave) communication system.

FIG. 2 is another illustration of the base station coverage area.

FIGS. 3A-B are illustrations of the Earth, a radius through a base station site on the surface of the earth, and an X-Y plane tangential to the surface of the earth and perpendicular to the radius.

FIG. 4 is a simplified block diagram of a set of base stations within a base station site.

FIG. 5 is an illustration showing the base stations of a base station site.

FIG. 6 shows another illustration of such a system in which several base station sites and a Coordination and Control Center (CCC) are coupled to the core network.

FIG. 7 is an illustration of an alternative embodiment in which base stations within the same base station site are part of a wired local area network and/or a wireless local area network.

FIG. 8 is a simplified block diagram of one example of some portions of a base station site, including some of the details of the transmit portion of a base station sector radio.

FIG. 9 is a simplified block schematic of the components of the RF TX chain. The RF TX chain has several inputs.

FIG. 10 is a simplified block diagram of one example of some portions of a base station site, illustrating some of the details of the receive portion of a base station sector radio.

FIG. 11 is a simplified schematic of the components of the RF receive chain.

FIG. 12 is a simplified schematic of a base station site illustrating some of the transmit components of the sector radio in accordance with an alternative embodiment such as the base stations shown in FIG. 7 in which a coordination control module is shared by all of the base stations.

FIG. 13 is a simplified schematic of the base station site of FIG. 12 illustrating some of the receive components of the sector radio.

FIG. 14 is a flow diagram illustrating the operation of some embodiments of the present disclosure for mitigating effects of interferences in radio frequency communication systems.

FIG. 15 is a block diagram of a communication device configured to detect and mitigate effects of interferences in radio frequency communication systems according to some embodiments of the present disclosure.

FIG. 16 is a flow diagram further illustrating a determination operation by the statistical analysis module of the embodiment shown in FIG. 15.

FIG. 17 is a block diagram of a communication device configured to detect and mitigate effects of interferences in radio frequency communication systems according to another embodiment of the present disclosure.

FIG. 18 is a flow diagram further illustrating another operation of the embodiment shown in FIG. 15.

FIG. 19A is a flow diagram of an operation performed by the embodiment shown in FIG. 15.

FIG. 19B is an example timing diagram which, in conjunction with FIG. 19A, illustrates the amount of interference over time.

FIG. 20A is a flow diagram of an operation performed by the embodiment shown in FIG. 15.

FIG. 20B is an illustration of the environment in which the operations disclosed in FIG. 20A may be performed.

Like reference numbers and designations in the various drawings indicate like elements.

### DETAILED DESCRIPTION OF THE INVENTION

Examples are described herein in the context of an architecture that mitigates effects of interferences in radio frequency, such as millimeter wave (mmWave), communication systems. Embodiments provided in the following description are illustrative only and not intended to limit the scope of the present disclosure. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in any such actual implementation, numerous implementation-specific details may nevertheless exist in order to achieve goals such as compliance with application- and business-related constraints, and that these specific goals can vary from one implementation to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “some embodiments”, “in one example”, “in an example”, “in one implementation”, or “in an implementation”, or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

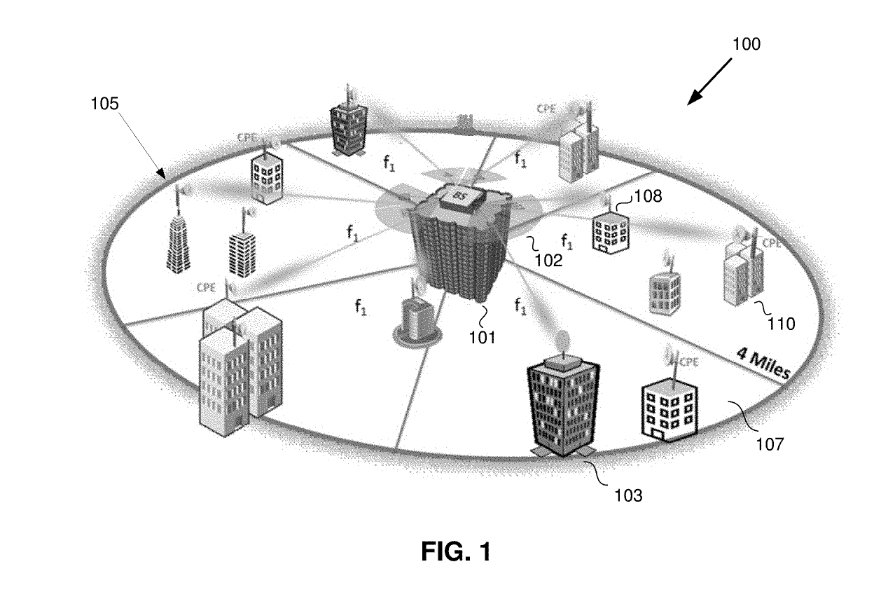

FIG. 1 is an illustration of a base station site 101 and several subscriber units 103 within a millimeter wave (mmWave) communication system 100. In some embodiments, several base stations 102 are located at each base station site 101. The base station site 101 serves as a hub for communications to the subscriber units 103. The system provides point-to-multipoint communications from the base station site 101 to each subscriber unit 103 over a “downlink”. In addition, the base station site 101 provides multipoint-to-point communications from each subscriber unit 103 to a base station 102 at the base station site 101 over an “uplink”. Subscriber units 103 may be located within various types of facilities, such as residential buildings, office buildings, towers of base stations within one or more mobile communications networks. Each subscriber unit 103 includes subscriber unit that supports the functions of the subscriber unit 103. A base station coverage area 105 (i.e., the geographic area serviced by one or more of the base stations 102 within a base station site 101) is divided into several base station sector coverage areas 107 (hereafter referred to as “sectors” for the sake of brevity). In some embodiments, each base station 102 within the base station site 101 services one sector of the base station coverage area 105. Accordingly, each base station 102 is associated with a corresponding sector 107. Each base station 102 is responsible for communicating with all of the subscriber units 103 within the corresponding sector 107. In the example shown in FIG. 1, the base station coverage area 105 is divided into six such sectors 107. For the sake of simplicity, the base station coverage area 105 is shown in FIG. 1 as a generally circular area with a radius of approximately 4 miles. Each sector 107 is shown as an essentially pie shaped region. It should be understood however that the actual base station coverage area 105 may not have a uniform shape, but rather a shape that is dependent upon obstructions, terrain and other transmission channel factors. Furthermore, each sector 107 may intersect with one or more adjacent sector 107 to a greater or lesser degree than is shown in the example of FIG. 1. Furthermore, in some embodiments, each sector 107 may have a coverage area that is substantially different in size and shape from one or more of the other sectors 107.

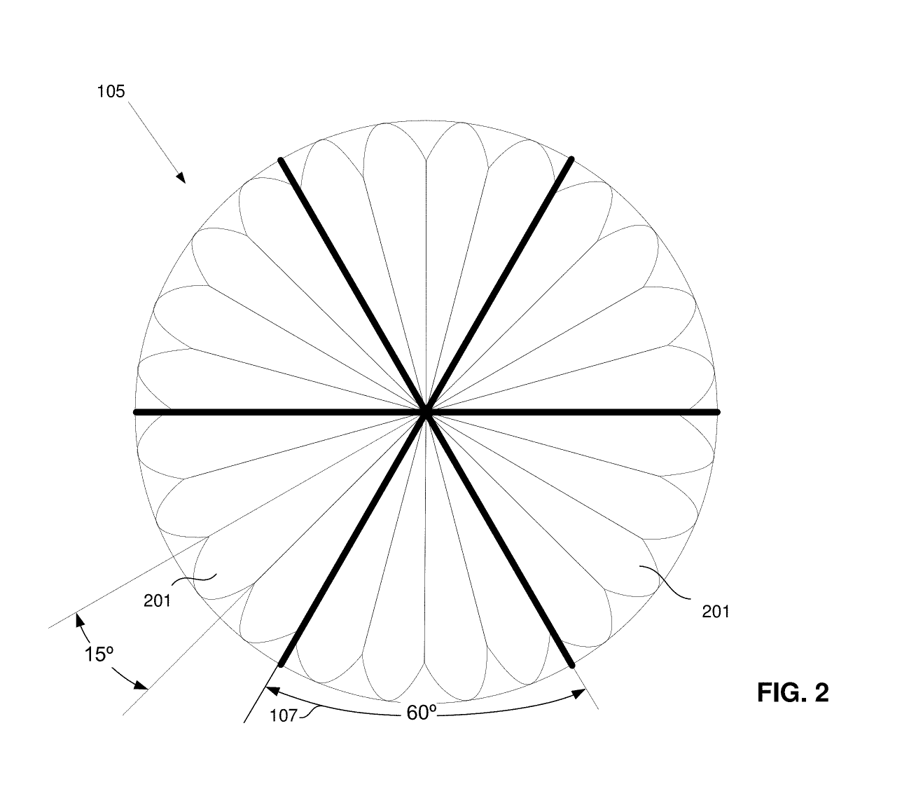

FIG. 2 is another illustration of the base station coverage area 105. In various embodiments of the disclosed method and apparatus, the particular number of sectors 107 may vary from that illustrated in FIG. 1 and FIG. 2. In the example shown in FIG. 2, each sector 107 is divided into four subsectors 201. Each subsector 201 extends out from the base station 101 with an azimuth angle of approximately 15 degrees, wherein the azimuth angle is an angle on an X-Y plane approximately perpendicular to the Earth's radius through the site of the base station 101.

The particular number and shape of the subsectors 201 may vary from the number shown in the example illustrated in FIG. 2. However, having four subsectors is compatible with a system in which an 802.11 compliant MAC provides 8 spatial streams, two of which can transmitted into each subsector with each of the two being transmitted on a different polarization. In some embodiments each of the two polarizations associated with one subsector are orthogonal. A sub-sector antenna (not shown in FIG. 1 or 2) is associated with each corresponding polarization of each subsector and defines the shape and size of the subsectors 201 within the sector 107, as will be discussed in greater detail below. Accordingly, in such embodiments, there are 8 such subsector antennas within each sector.

As is the case with the sectors 107, each subsector 201 can have a substantially different size and shape from that of the other subsectors 201 within the same sector 107 or from the other subsectors 201 in each other sectors 107. Furthermore, in some embodiments, there may be more or less than 6 sectors, each with more or less than 4 subsectors. In some embodiments, the sum of all of the azimuth angles for each sector may not be equal to 360 degrees. Accordingly, there may be some holes in the coverage where no subscriber units 103 are expected to be present, or in other embodiments, there may be an overlap in the coverage of two or more adjacent sectors. In addition, in some embodiments, the number of subsectors may vary from one sector to another and one or more subsectors may have different azimuth angles than one or more of the subsectors within the same sector or within other subsectors.

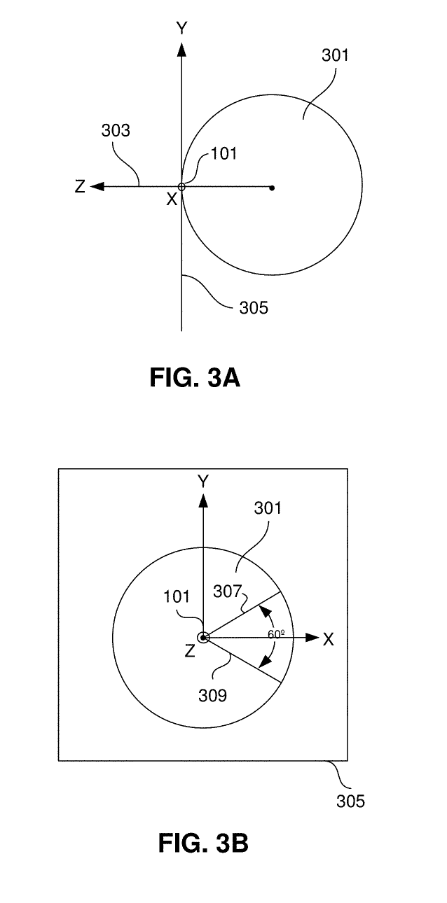

FIG. 3A is an illustration of the Earth 301, a radius 303 through a base station site 101 on the surface of the earth 301, and an X-Y plane 305 tangential to the surface of the earth 301 and perpendicular to the radius 303. FIG. 3A is oriented such that the X-axis extends outward, the Y-axis extends upward and the Z-axis extends to the left.

FIG. 3B is an illustration of the Earth 301, the X-Y plane 305 and a pair of rays 307, 309 emanating from the base station site 101 that define an azimuth angle of 60 degrees. The orientation of the illustration in FIG. 3B is rotated 90 degrees about the Y-axis with respect to the illustration of FIG. 3A. Accordingly, in FIG. 3B, the Y-axis extends upward, the X-axis extends to the right and the Z-axis extends outward (making the radius 303 extend outward and thus not visible in FIG. 3B). As can be seen in FIG. 3B, azimuth angle lies on the X-Y plane. It should be clear that the radius of the Earth is significantly greater than the dimensions of the base station coverage area 105. Therefore, that portion of the X-Y plane 305 that is coincident with the base station coverage area 105 is generally also coincident with the surface of the Earth. Furthermore, rays emanating from the base station site 101 that lie on the plane 305 are projected from the base station site 101 at an elevation angle of zero degrees. Contours of the Earth's surface, however can be taken into account when aiming the antennas. Therefore, the center of any beam transmitted from a base station 102 within the base station site 101 may be at an elevation angle other than zero degrees.

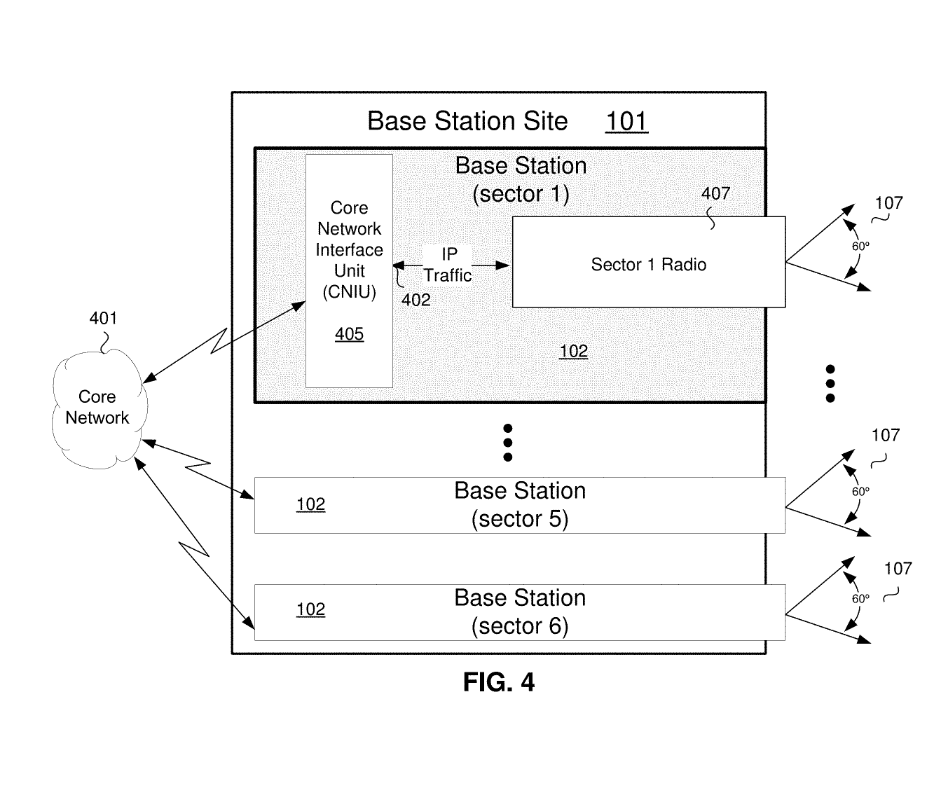

FIG. 4 is a simplified block diagram of a plurality of base stations 102 within a base station site 101. In the example shown in FIG. 4, the base station site 101 has 6 base stations 102. Accordingly, there are 6 sectors 107 in the base station coverage area 105. Each sector 107 is serviced by a base station 102 having a coverage area with an azimuth angle of approximately 60 degrees. In some embodiments, each base station 102 has a core network interface unit (CNIU) 405. The CNIU 405 provides a means by which the base station 102 can communicate, such as via IP Traffic 402, with other nodes on a core network 401. Accordingly, in some embodiments, the CNIU 405 provides access to other base stations at other base station sites or other base stations located at the same base station site 101.

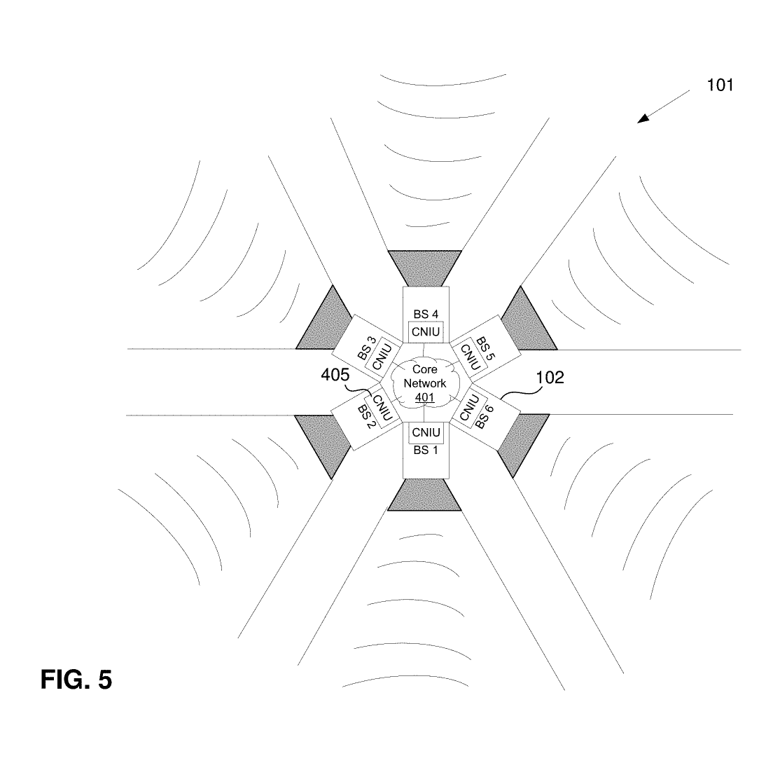

FIG. 5 is an illustration showing the base stations 102 of a base station site 101. Each of the six base stations 102 are coupled to a core network 401 in accordance with some embodiments of a communication system. Only one base station site 101 is shown in FIG. 5 for the sake of simplicity.

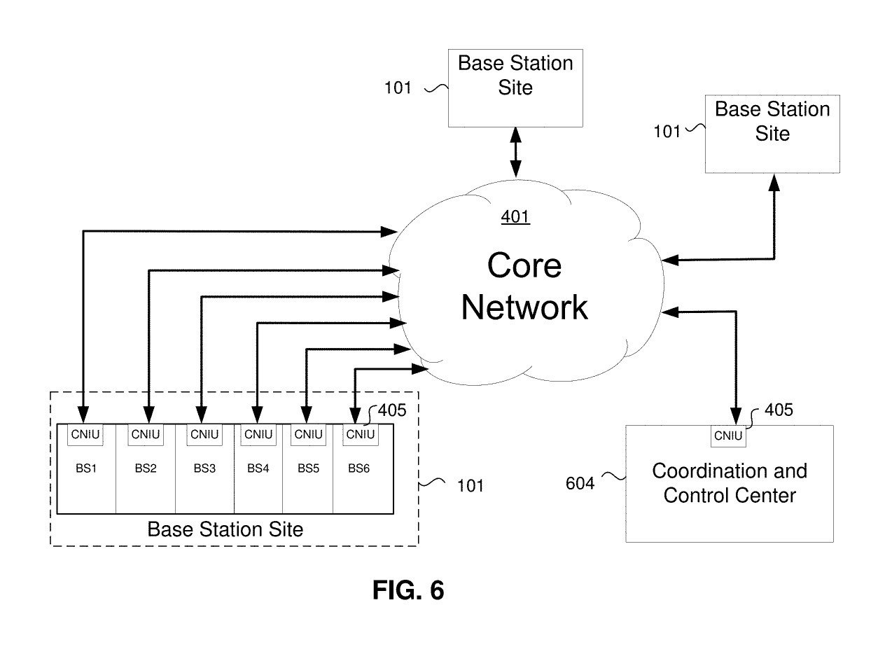

FIG. 6 shows another illustration of such a system in which several base station sites 101 and a Coordination and Control Center (CCC) 604 are coupled to the core network 401. The CCC 604 has a CNIU 405. The CNIU 405 allows the CCC 604 to be a node on the Core Network 401. In FIG. 6, the base stations 102 and core network interface unit of only one base station site 101 are shown. The other two base station sites 101 are shown as blocks for the sake of simplicity. In some such embodiments, the CCCs 604 coordinate operations between base stations 102 within each base station site 101.

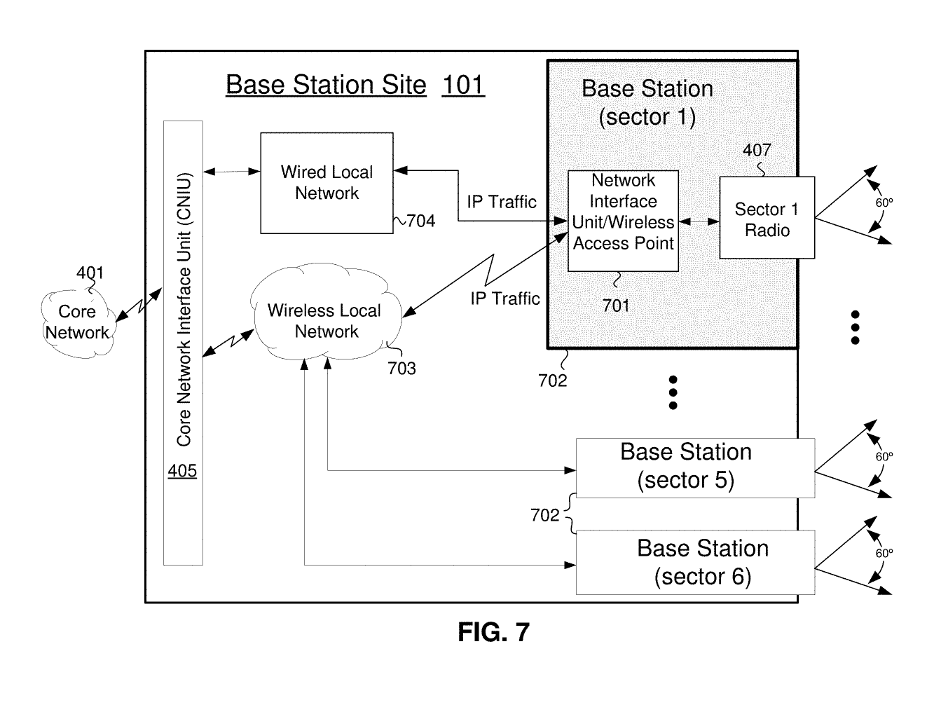

FIG. 7 is an illustration of an alternative embodiment in which base stations 702 within the same base station site 101 are part of a wired local area network 704 and/or a wireless local area network 703. Therefore, each base station 702 has a network interface unit (NIU) 701 that provides access to the local area network 704, 703. A CNIU 405 is also a node on the local area network 704, 703. Accordingly, each base station 702 can access the core network 401 through the local area network 704, 703 through one CNIU 405 that is present in the base station site 101.

In either the case of the base station 102 or the base station 702, the base station site 101 provides a means by which subscriber units 103 can be connected to devices that are part of a private network, public network or the Internet through devices (such as Internet gateways) connected to the core network. In addition, in some embodiments, the base station 102, 702 can provide communication links through sector radios 407 of the base station 102, 702 to allow two or more of the subscriber units 103 to communicate with each other through the base station 102, 702.

It should be noted that throughout the remainder of this document, references to the base station 102 apply equally to the base station 702.

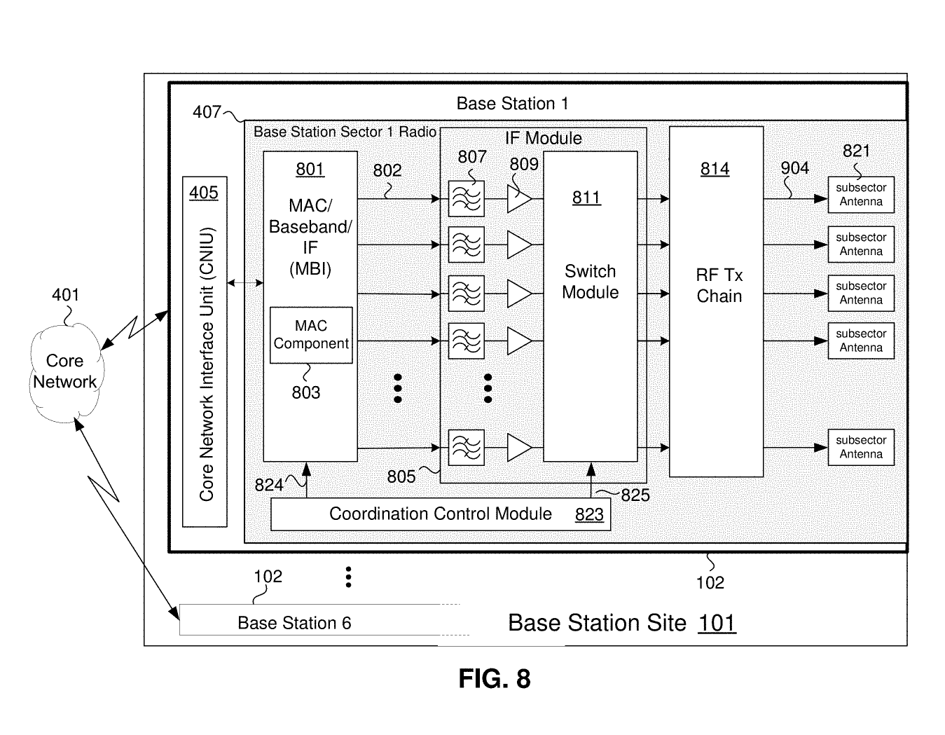

FIG. 8 is a simplified block diagram of one example of portions of a base station site 101, including some of the details of the transmit portion of a base station sector radio 407. For the sake of simplicity, only one base station sector radio 407 is shown in detail. In addition, only the transmit related components are shown in FIG. 8.

In the example shown in FIG. 8, each base station 102 transmits mmWave signals into the sector 107 corresponding to that base station 102. Each of the six base stations 102 has a corresponding base station sector radio 407. In some embodiments, each such base station sector radio 407 has essentially the same architecture. However, in other embodiments, the architecture of one or more of the base station sector radios 407 may differ from the rest. In some such embodiments, each of the base station sector radios 407 has an architecture that is uniquely configured for the needs of the particular sector 107 that the radio 407 services.

In one example of a base station 102 shown in FIG. 8, signals containing content to be transmitted by the radio 407 are coupled from the CNIU 405 to a MAC/Baseband/Intermediate Frequency (MBI) module 801. In some embodiments of the disclosed method and apparatus, the MBI module 801 is capable of providing spatial division, time division and frequency division outputs 802 at an intermediate frequency (IF). That is, the MBI module 801 is capable of outputting signals 802 that carry unique information through different outputs that are coupled to spatially diverse antennas, and thus provide spatial division.

In addition, the MBI module 801 is capable of outputting signals 802 to each output, wherein each such signal has unique content at different times. Thus, the outputs provide time division multiplexed signals. Still further, the MBI module 801 is capable of providing unique content concurrently through each output at different frequencies, thus provide frequency division multiplexed signals. In some such embodiments, the MBI module 801 includes at least an 802.11 module, such as module capable of operating in conformance with one of the following: industry standard 802.11(n), 802.11(ac), 802.11(ax), etc. In some embodiments, the MBI module 801 implements a technique commonly referred to as multiple-input multiple-output (MIMO) to generate spatial division outputs. Each spatial division output is commonly referred to as a “spatial stream” (SS). In some embodiments, such as those that have a MBI module 801 that operates in conformance with 802.11(ac) or 802.11(ax), the MBI module 801 may have eight output ports that each output one SS 802. A media Access Control (MAC) component of the MBI module 801 (which in some embodiments is within the 802.11 module of the MBI module 801) determines how the content that is coupled to the MBI module 801 is to be assigned to each SS 802. In addition to determining which SS 802 the content is to be assigned, the MAC component 803 also determines time and frequency division allocations. That is, the MAC component 803 determines in what time slot and to which frequency the content is to be applied in each particular SS 802.

In some embodiments, each SS 802 is associated with a corresponding TX input to an IF module 805. In some such embodiments, the IF module 805 comprises a switch module 811 and several filters 807, each filter 807 associated with a corresponding amplifier 809. Since FIG. 8 shows only components that are associated with the transmit function, only those TX amplifiers 809 and TX filters 807 that are in the transmit signal path are shown in FIG. 8.

Each TX output from the MBI module 801 is associated with a corresponding one of the IF module TX inputs and the corresponding TX filter 807. The output of each TX filter 807 is coupled to the input of the corresponding TX amplifier 809. It will be understood by those skilled in the art that the use of particular amplifiers and filters will depend upon the requirements of each particular system. Therefore, it should be understood that the configurations disclosed herein are merely provided as examples of systems. Therefore, significant variations in the amount of filtration and amplification are within the scope of the disclosed method and apparatus.

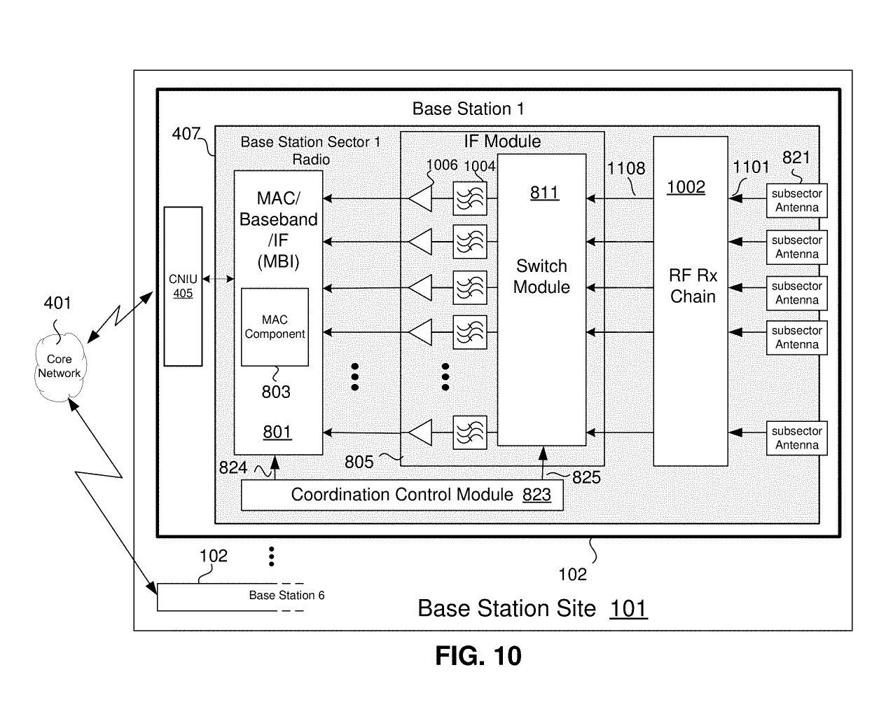

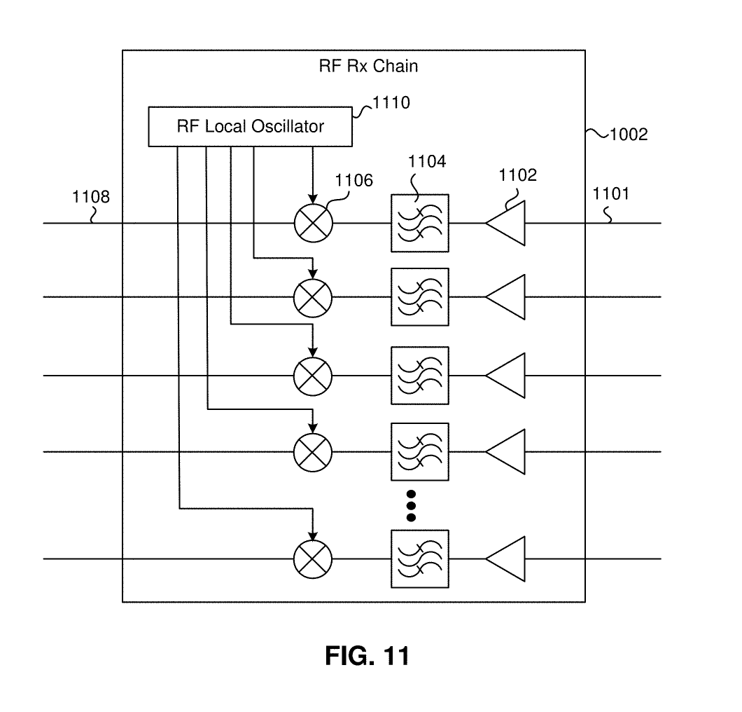

The output of each TX amplifier 809 is associated with, and coupled to, a corresponding TX input to a switch module 811 within the IF module 805. The switch module 811 comprises a switch network that makes it possible to selectively connect any one input to any one output. Likewise, each output can be connected to any one input. Therefore, there is a selectable one-to-one correspondence between TX inputs and TX outputs of the switch module 811. Other embodiments may provide a switch module that is capable of selectively connecting one or more inputs to one or more outputs. Each TX output from the switch module 811 is associated with a corresponding input to an RF transmit (TX) chain 814. It should be noted that the switch module 811 also comprises RX inputs and RX outputs that will be discussed further below with respect to FIG. 10 and FIG. 11.

While the MBI 801 shown in FIG. 8 has several TX outputs, in some embodiments, the MBI 801 may have as few as two TX outputs, each associated with a corresponding one of two subsector antennas 821. In some such embodiments, the two subsector antennas 821 are focused into the same subsector and transmit signals with different polarizations (e.g., horizontal polarization and vertical polarization).

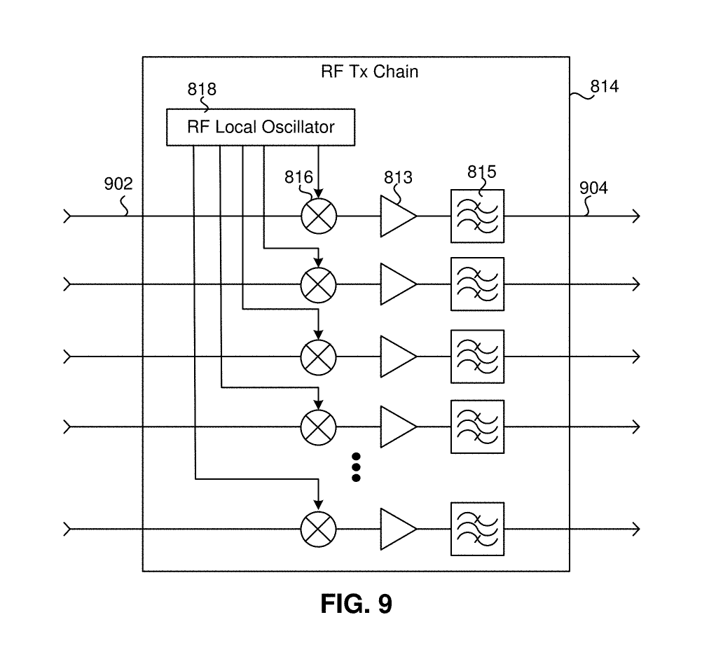

FIG. 9 is a simplified block schematic of the components of the RF TX chain 814. The RF TX chain 814 has several inputs 902. Each input 902 is associated with a corresponding frequency converter 816, amplifier 813, filter 815 and output 904. Each RF TX chain input is coupled to a corresponding IF input of the corresponding frequency converter 816. A local oscillator 818 provides a local oscillator signal to each frequency converter 816. Each frequency converter 816 mixes the input signal with the local oscillator signal to upconvert the IF signal to a millimeter wave frequency that is output from the frequency converter 816. The upconverted signal output from each frequency converter is coupled to the corresponding amplifier 813. The output of each amplifier 813 is coupled to the input of the corresponding filter 815.

Referring back to FIG. 8, each output 904 from the RF TX chain 814 is associated with, and coupled to, a corresponding input to a subsector antenna 821. Each input to the subsector antenna 821 is configured to form a beam directed to a corresponding subsector 201 of the sector 107 serviced by the base station sector radio 407. In some embodiments, there are two inputs focused into the same subsector 201. The first is applied to elements of the antenna that polarize the signal in a first polarization. The second is applied to elements of the antenna that polarize the signal in a second polarization orthogonal to the first polarization. For example, in some embodiments, a first input to the sector antenna 821 is coupled to elements that transmit signals in a beam focused upon a first subsector 201 and having a horizontal polarization. A second input to the sector antenna is coupled to elements that transmit signals in a beam focused upon a second subsector 201 and having a vertical polarization. Therefore, by selecting a particular output of the switch module 811 to which a particular input of the switch module 811 is to be coupled, the signal output from the amplifier 809 is selected for transmission on a transmission beam that is focused into the subsector 201 associated with the selected switch module output. In some embodiments, selecting a particular output further determines the polarization on which the signal will be transmitted. In the embodiment in which there are four subsectors 201, there eight subsector antennas 821. The subsector antennas 821 are paired such that each pair of subsector antennas 821 is focused to transmit beams into one of the four subsectors. A first subsector antenna 821 of each pair transmits signals having a first of two orthogonal polarizations (e.g., vertical or horizontal). The second subsector antenna 821 of the pair transmits signals on the second of the two orthogonal polarizations. Accordingly, each output of the switch module 811 is associated with a corresponding subsector antenna 821 focused to transmit a signal into a unique one of the four subsectors 201. Furthermore, the combination of polarization and subsector 201 is unique for each output of the switch module 811.

Ideally, in a typical 802.11 configuration, such as an 802.11(ax) configuration, each SS 802 is coupled to a different antenna to provide the spatial diversity desired to implement a MIMO transmission. In the embodiment of FIG. 8, a multi-user MIMO system is used in which each pair of SSs carries different content to subscriber units 103 in a different subsector 201. At least two antennas within the receiver of each subscriber unit 103 can receive signals from the subsector antennas 821 of the transmitter that transmit beams into the subsector 201 in which the subscriber unit 103 resides. Some typical 802.11 systems take advantage of MIMO techniques to increase the system throughput. Multipath channels are created by the creation of different signal paths that form as a consequence of the signals reflecting off various objects along the path between the transmitter and the receiver, creating associated different delays for each signal path. However, in accordance with some embodiments of the disclosed method and apparatus, rather than relying upon signals encountering multipath channels between the transmit antennas and the receive antennas, each SS is transmitted on a transmission beam that is focused into a unique subsector 201 of the sector 107 on a unique polarization. In some embodiments, two SSs are transmitted into the same subsector 201. However, the two signals are transmitted on beams that have orthogonal polarizations. By virtue of the signals being transmitted through elements of the transmit antenna that are either on different polarizations or directed at different subsectors 201, the signals will be in different channels for the purpose of the MIMO system, similar to the different spatial channels in a typical 802.11 MIMO configuration. A coordination control module 823 coordinates the assignment of SSs output from the MBI module 801 with the switch module 811 (i.e., the selection of the output to which each particular SS is coupled by the switch module 811).

In other embodiments, signals that are not completely orthogonal may be transmitted into the same subsector 201. In such embodiments, a technique commonly known as non-orthogonal multiple access (NOMA) is used in which such signals that are not completely orthogonal are transmitted on the same frequency and at the same time into the same space, relying upon a difference in polarization (or other factor that can be used to distinguish signals), but wherein the signals are not completely orthogonal. For example, a first signal may have polarization that is between horizontal and vertical (e.g., at 45 degrees from horizontal), while other signals are either strictly horizontal, strictly vertical, or 90 degrees from the first signal. While some such signals are not orthogonal, the difference in polarization is sufficient to provide some measure of separation that provides the receiver with a limited capability to distinguish the signals from one another. Therefore, while the separation of the signals is not nearly as great as for orthogonal polarizations, there is sufficient separation to provide some advantages that, when taken together with the increase in throughput, offset the negative impact of distortion created by the cross contamination of the signals.

In some embodiments of the disclosed method and apparatus, the MAC component 803 is responsible for allocating resources to each subscriber unit 103. That is, the MAC component 803 determines which SS 802 at which frequencies and at which time is to be used to transmit content to each particular subscriber unit 103. It should be noted that in addition to providing signals with time division, frequency division and spatial division, the signals provided by the MBI module 801 may be modulated using orthogonal frequency division multiplexing (OFDM). In some cases, the content modulated on various OFDM subcarriers may be intended for reception by different subscriber units 103 (i.e., orthogonal frequency division multiple access (OFDMA)). Alternatively, different OFDM subcarriers may carry different data streams intended for the same subscriber unit 103. In some embodiments, the MBI module 801 receives instructions from the coordination control module 823 that assist the MBI module 801 and the MAC component within the MBI module 801 to determine the manner in which the resources are to be allocated.

In many ways, the operation of the MAC component 803 of the disclosed method and apparatus is similar to the operation of a MAC within a conventional 802.11(n), 802.11(ac) or 802.11(ax) system. That is, the MAC component 803 need not treat the SSs 802 that are output any different from those SSs that are output from a MAC of a conventional 802.11 system. However, because SSs 802 are transmitted to the subscriber units 103 residing in different subsectors using different subsector antennas 821, determinations of Channel State Information (SCI) by the MAC component 803 needs to be coordinated with the switch module 811 within the IF module 805. For example, the channel from the base station 102 to a particular subscriber unit 103 depends upon the subsector 201 in which the subscriber unit 103 is located. The coordination control module 823 performs the function of controlling the switch module 811 in coordination with the MAC component 803 of the MBI module 801. For example, in some embodiments, when the SCI is being measured for the channel from a first output of the MBI module 801 during transmission from a first subsector antenna 821, the switch module 811 is controlled to ensure that the first output from the MBI module 801 is coupled to the first subsector antenna 821. In some embodiments, a control signal is coupled on a line 824 from the coordination control module 823 to the MBI module 801 to allow the MBI module 801 to be coordinated with the switch module 811 during a SCI procedure. In some embodiments, the switch module 811 is controlled by a signal output on a signal line 825 from the coordination control module 823. Similarly, each other output from the MBI module 801 is coupled to the appropriate subsector antenna 821 during measurements of the channel between the base station 102 and the subscriber unit 103 at issue. A further discussion regarding the determination of SCI for each channel is provided below. Once the SCI procedure is complete, the coordination control module 823 ensures that the signals that are output from the MBI module 801 are coupled to the appropriate subsector antenna 821 for transmission of MIMO signals from the base station 101 to each subscriber unit 103 to which the base station 101 is communicating. In some embodiments, such as the embodiment shown in FIG. 6, the coordination control module 823 is coupled to the MBI module 801 and also to the IF module 805. In particular, in some embodiments, the coordination control module 823 is coupled to the switch module 811 in the IF module 805.

For MIMO operations, SCI regarding the channels between the various antennas at the base station 102 and the antennas of each subscriber unit 103 must be determined. The SCI information is used by the base station to pre-code transmissions to subscriber units taking into account distortions that occur due to the nature of the transmission channel between the transmitter and the receiver. Conventions and protocols for attaining SCI are provided in the 802.11 standard. In particular, there are two protocols that are provided in 802.11 for attaining SCI. The first is referred to as “Implicit” and the second is referred to as “Explicit”.

In accordance with the Explicit technique for determining SCI, the base station 102 sends a “null data packet announcement” (NDPA) frame to the subscriber units. Usually, the NDPA frame contains the address of the intended subscriber units 103, the type of feedback requested and the spatial rank of the requested feedback. The base station 102 then sends a “sounding frame” known as a “null data packet” (NDP) frame. The NDP contains a physical layer (PHY) preamble with long training fields (LTFs), short training fields (STFs) and a signal (SIG) field. The NDP contains no data. The subscriber unit 103 then analyzes the NDP and provides back a report for each receive antenna (i.e., each SS). The base station 102 then uses the report to precode further transmissions to those subscriber units 103 from which reports were received. The reports are typically relatively large and require a significant amount of bandwidth. In some embodiments, such precoding is done by a combination of the coordination control module 1023 and the MBI module 801. In particular, in some embodiments, the MAC component 803 of the MBI module 801 applies precoding to signals output from the MBI module 801. In some embodiments, the coordination control module 823 may be coupled to the amplifier 813.

In accordance with the implicit technique for determining the SCI, the base station 102 requests the subscriber unit 103 to send the NDP frame. The base station 102 can then determine the precoding of the transmissions to the subscriber unit 103 based on the NDP frame without the report having to be communicated. This saves a substantial amount of bandwidth in the SCI procedure. In order to use the implicit technique, however, the uplink and downlink have to be reciprocal. While some differences may occur between the uplink and downlink of a mmWave system using TDD, the differences can typically be considered to be negligible when conditioning (e.g., precoding) the signals. That is, because the same frequency is used for both the uplink and the downlink, the channel characteristics will typically be the same or close enough to allow the information derived from the uplink to be used to precode signals on the downlink.

Accordingly, the implicit SCI procedure defined by the 802.11 standard can be used with a modification that the SSs output from the MBI module 801 have to be coordinated with the operation of the switch module 811 to ensure that the signals are transmitted to the desired subsector antennas, and thus to the intended subscriber units 103. In addition, beamforming that is performed by adjusting the gain and phase of the signals coupled to each subsector antenna 821 must be coordinated with the operation of the MBI module 801. The coordination control module 823 coupled to the MBI module 801 and the switch module 811 ensures the coordination of the switch module 811 and MBI module 801 during both the SCI procedure and normal operation.

As noted above, in addition to coordinating the SCI operations, the coordination control module 823 is also responsible for ensuring that SSs output from the MBI module 801 are routed by the switch module 811 to the appropriate feed of the appropriate subsector antenna 821 during normal operation. That is, the coordination control module 823 is responsible for ensuring that each SS output from the MBI module 801 is transmitted on the correct polarization and subsector antenna 821. In some embodiments, the coordination control module 823 has an output that is coupled over a signal line 824 to an input of the MBI module 801. The output from the coordination module 823 provides information that allows the MBI module 801 to determine that the SCI procedure can be performed (i.e., that the output from the MBI module 801 associated with channel being measured is coupled to the appropriate subsector antenna 821).

FIG. 10 is a simplified block diagram of one example of some portions of a base station site 101, illustrating some of the details of the receive portion of a base station sector radio 407. For the sake of simplicity, only one base station sector radio 407 is shown in detail. In addition, only the components relevant to the receiver operation of the base station 102 are shown in FIG. 10. The operation of the receive sections of the base station 102 are similar to the operation of the transmit section. The signal flow however is from the subsector antenna 821 to the MBI 801. Signals received by the subsector antennas 821 are coupled to an RF receive (RX) chain 1002.

FIG. 11 is a simplified schematic of the components of the RF receive chain 1002. Each input 1101 of the RF receive chain 1002 is associated with a corresponding amplifier 1102, filter 1104, frequency converter 1106 and output 1108. Signals coupled to the RF receive chain 1002 are coupled to the input of the corresponding amplifier 1102. The output of the amplifier 1102 is coupled to the input of the corresponding filter 1104. The output of the filtered 1104 is coupled to the RF input of the corresponding frequency converter 1106. A local oscillator input to the frequency converter 1106 is coupled to an RF local oscillator (LO) 1110. The LO 1110 provides an LO signal to down convert the received RF signal to an IF frequency. The IF output of the frequency converter 1106 is then coupled to the output 1108 of the RF receive chain 1102.

Referring back to FIG. 10, the RX outputs from the switch module 811 are each associated with a corresponding filter 1004. Accordingly, the switch module 811 provides selectable one-to-one coupling of the outputs 1108 of the RF RX chain 1002 to the inputs of a filter 1004 within the IF RX module 805. The output of each filter 1004 is coupled to the input of a corresponding amplifier 1006. As noted above, the particular configuration of amplifiers and filters depends upon the requirements of the particular radio 407. Therefore, the configuration shown in FIG. 10 and FIG. 11 is merely provided as an example of one particular embodiment. Other configurations in which more or less amplifiers and filters placed at the same or other places along the signal path are within the scope of the presently disclosed method and apparatus.

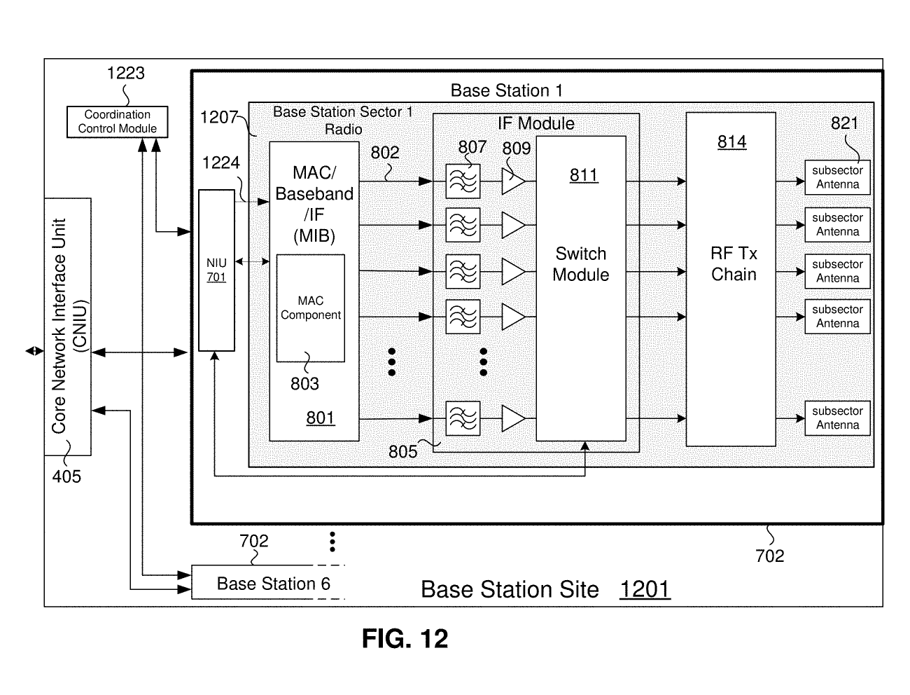

FIG. 12 is a simplified schematic of a base station site 1201 illustrating some of the transmit components of the sector radio 1207 in accordance with an alternative embodiment such as the base stations 702 shown in FIG. 7 in which a coordination control module 1223 is shared by all of the base stations 702. The coordination control module 1223 is responsible for coordinating the operation of the MBI modules 801 and switch modules 811 of each of base stations 702. In some embodiments, the coordination control module 1223 is a node on the WLAN 703 (see FIG. 7). The NIU 701 in each base station 702 is coupled to the MBI module 801 and IF module 805, so the coordination control module 1223 can coordinate the routing of SSs 802 through the switch module 811 of the IF module 805 with the assignment of the SSs 802 to the outputs of the MBI module 801. In some embodiments, the MAC component 803 of the MBI module 801 also adjusts the signals output from the MBI module 801 in response to the SCI measured during a SCI procedure. A control signal line 1224 between the NIU 701 and the MBI module 801 provides a connection through which the coordination control module 1223 can provide control signals to the MBI module 801 to coordinate the operation of the MBI module 801 with the operation of the switch module 811.

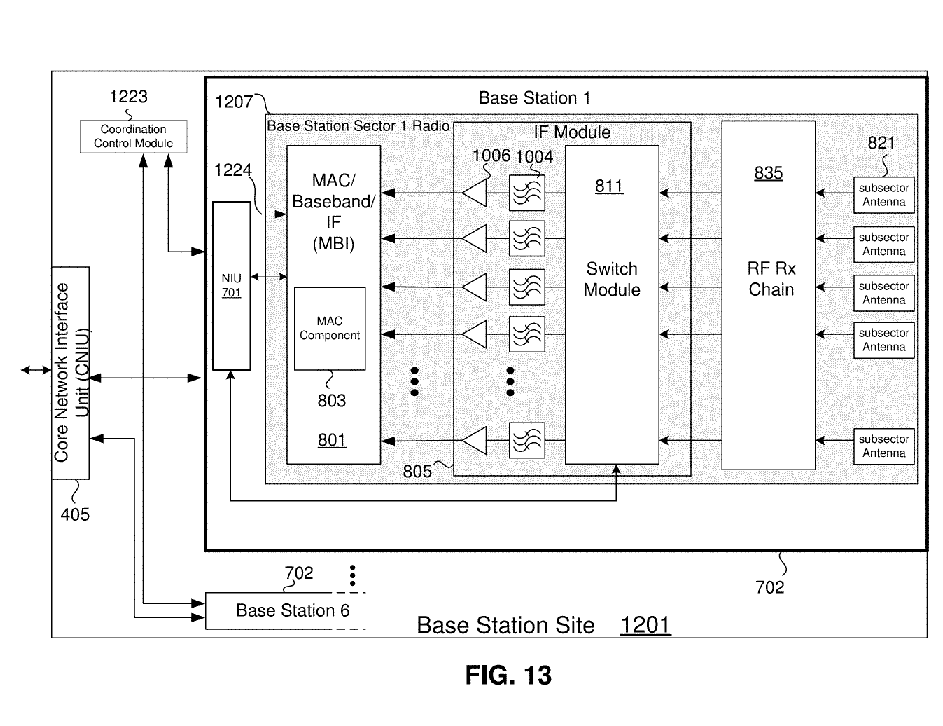

FIG. 13 is a simplified schematic of the base station site 1201 of FIG. 12 illustrating some of the receive components of the sector radio 1207. Similar to the case described above with respect to FIG. 12, the coordination control module 1223 provides signals to each base station 702 to coordinate control of the MBI 801 with the switch module 811. The signal flow through the base station radio 1207 is essentially the same as was described above with regard to the base station radio 407 of FIG. 10 with the exception of the coordination control module 1223 providing the control signals that coordinate the operation of the MBI 801 with the operation of the switch module 811.

The subsector antennas 821 within each base station sector radio 407 are a critical component of the base station 702. In accordance with some embodiments of the disclosure, each subsector antenna 821 is designed to focus signals into one of the subsectors 201 in the base station coverage area 105.

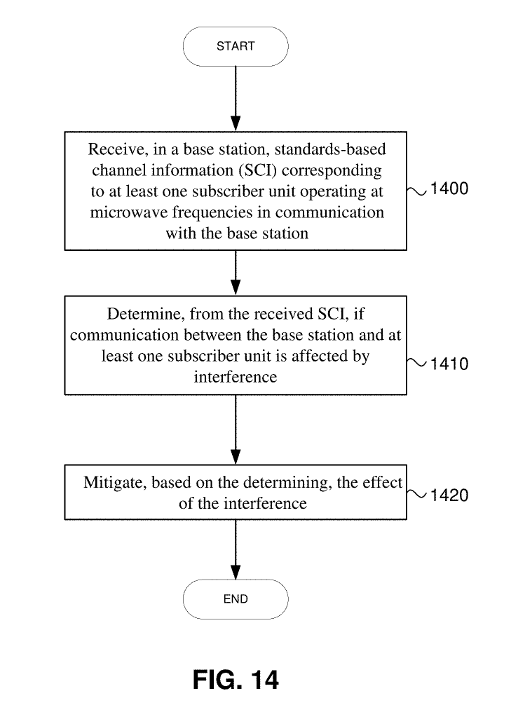

FIG. 14 is a flow diagram illustrating the operation of some embodiments of the present disclosure for mitigating effects of interferences in radio frequency (e.g. millimeter wave) communication systems.

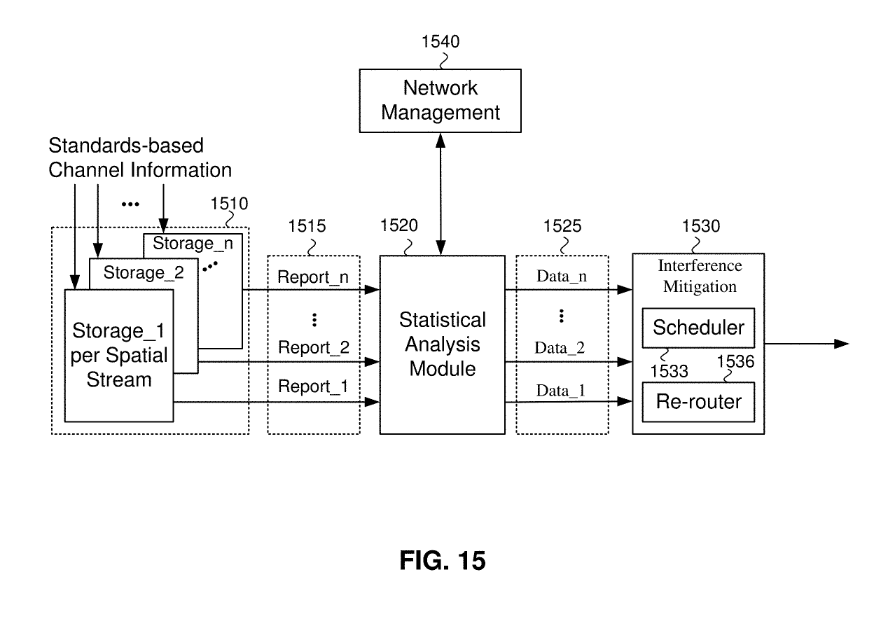

FIG. 15 is a block diagram of a communication device used to perform some of the functions illustrated in FIG. 14. The communication device of FIG. 15 is configured to detect and mitigate effects of interferences in radio frequency (e.g. millimeter wave) communication systems according to some embodiments of the present disclosure.

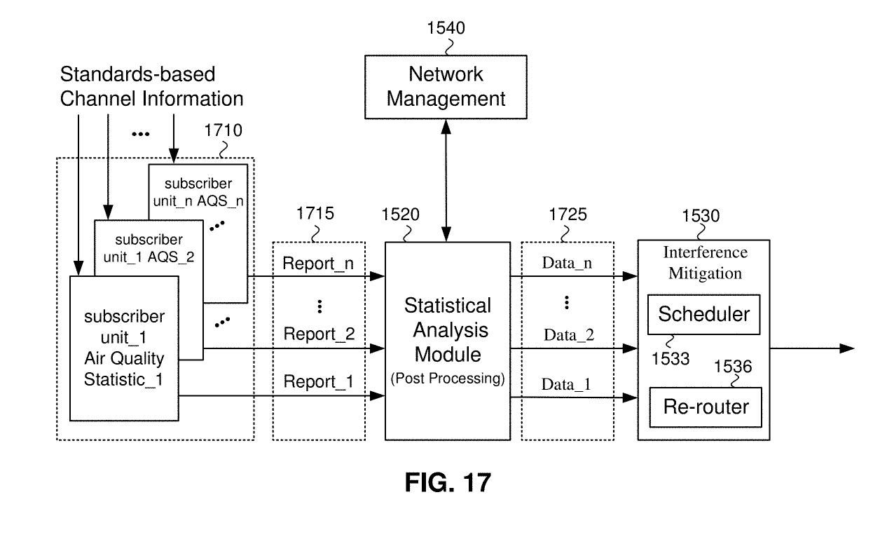

Referring to FIG. 14, the process begins in block 1400 wherein a statistical analysis module 1520 receives standards-based channel information (SCI), such as channel state information (CSI). The SCI is derived as noted above by a process that is performed by the subscriber units 103 and the base stations for each channel between a subscriber unit 103 and a base station. The process for determining the CSI is defined by IEEE 802.11 for use for other purposes, such as generating a set of beamforming reports 1515 (e.g. Report_1 to Report_n) taken for a set of spatial streams 1510 (e.g. Storage_1 to Storage_n). In another embodiment shown in FIG. 17, the SCI includes subscriber unit air quality information 1710 (e.g. 802.11k reports) is received from subscriber units 103. In some embodiments, the statistical analysis module 1520 may reside in a base-station or a subscriber unit 103. In some embodiments, received SCI is includes CSIs associated with one or more subscriber units 103 that are in communication with a base station, such as base station 102. That is, a portion of the SCI identifies the nature of each channel between a base station 102 and a subscriber unit 103. In some embodiments, a subscriber unit 103 operates at microwave frequencies, such as centimeter waves or millimeter waves, above 30 Ghz (e.g. 30-300 GHz range).

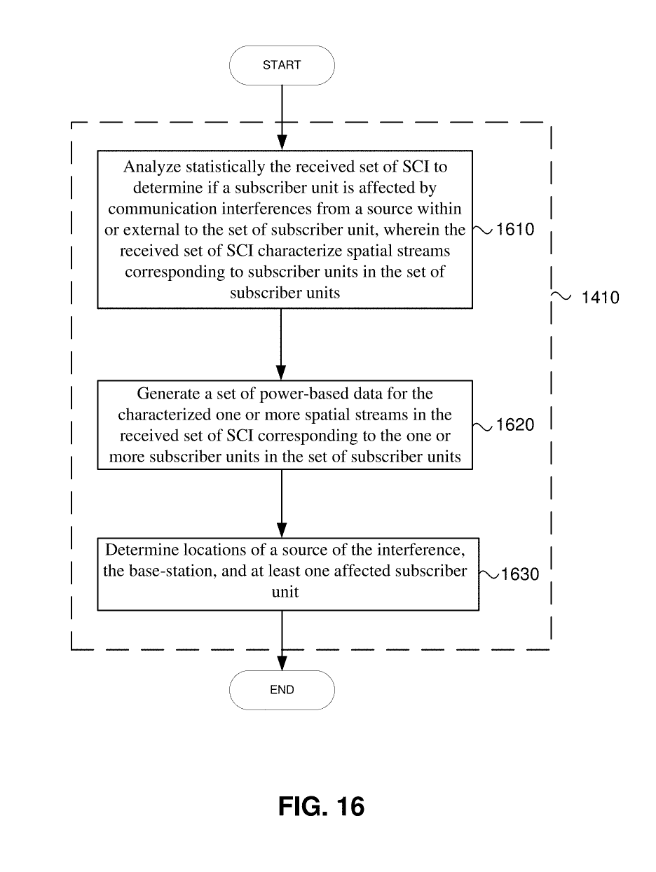

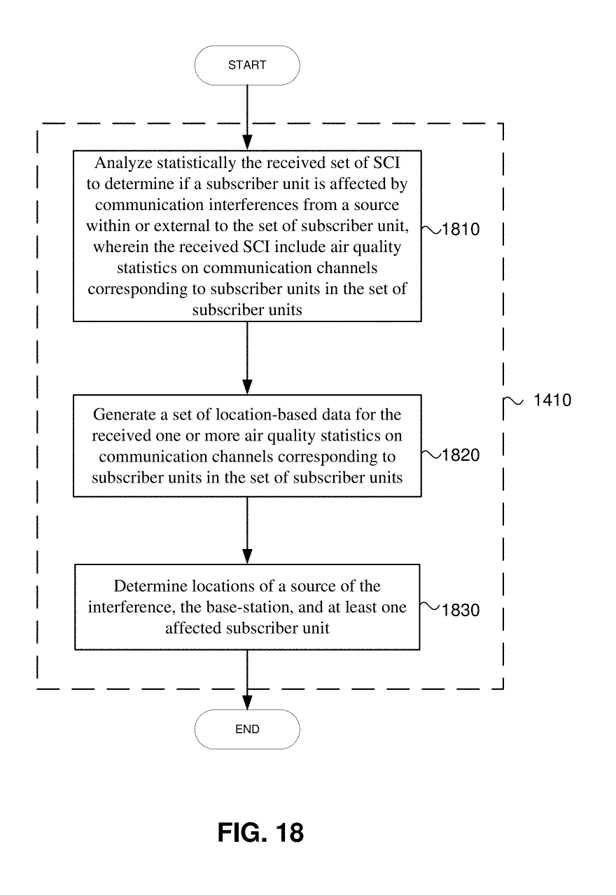

Next, in block 1410, the statistical analysis module 1520 determines, from the received beamforming reports 1515, if a communication between the base station 102 and at least one subscriber unit 103 is affected by interference, as described in greater detail further below in conjunction with FIGS. 16 and 18.

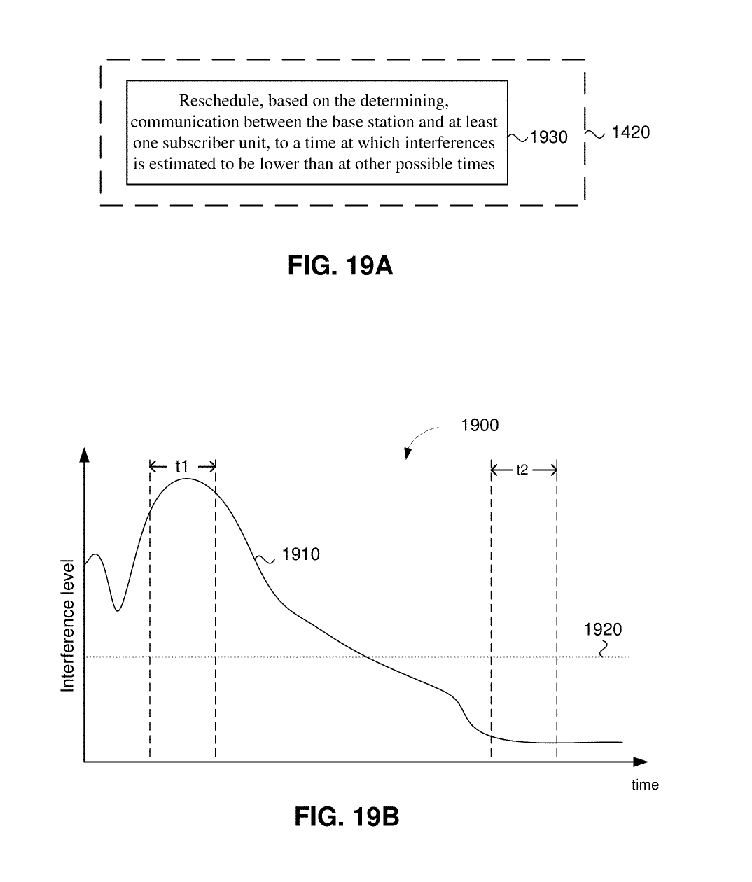

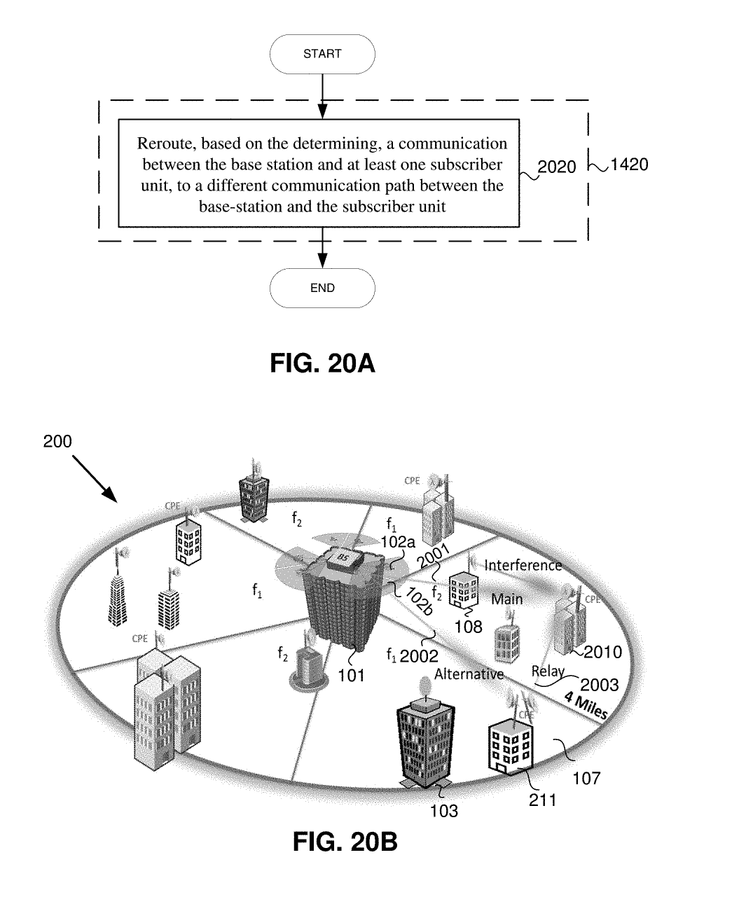

Next in block 1420, based on the determination of the statistical analysis module 1520, the effect of the interference is mitigated by the interference mitigation circuitry 1530, such as the scheduler 1533 or re-router 1536, configured to reschedule or re-route the communication, as described in greater detail further below in conjunction with FIGS. 19A to 20B.

FIG. 16 is a flow diagram further illustrating a determination operation by the statistical analysis module 1520 of the embodiment shown in FIG. 15. As shown in FIG. 16, in block 1610 the statistical analysis module 1520 statistically analyzes the received set of CSI beamforming reports 1515 to determine if a subscriber unit 103 is affected by communication interferences and or obstacles from (a) a source within the set of subscriber units 103, such as another subscriber unit, or (b) a source external to the set of subscriber units 103, such as other radio transmitters, line-of-sight (LoS) disturbances such obstructions or reflections from trees, other buildings and obstacles, or natural phenomena such as inclement or stormy weather. In some embodiments, the received set of CSI characterize the channel traversed by spatial streams 1510. Each channel exists between one or more subscriber units 103 in the set of subscriber units 103 and a base station 102. The set of beamforming reports 1515 (e.g. Report_1 to Report_n) determined for a set of spatial streams 1510 (e.g. Storage_1 to Storage_n) may be generated during a CSI procedure. In some embodiments, the beamforming reports in conformance with WiFi standards, such as for 802.11n, 802.11ac, 802.11ax or other 802.11 extensions, are used by the statistical analysis module 1520 to perform a statistical analysis to determine the nature of any interference on the channel.

In some embodiments, the spatial streams 1510 may include data on variations or disturbances on a per sub-carrier basis (e.g., corresponding to one or more subscriber units 103), such as differences in signal-to-noise (ASNR) ratio or signal to interference plus noise ratio (ASINR) between subcarriers. In some embodiments, the beamforming reports 1515 contain a data field that carries data on ΔSNR or ΔSINR between subcarriers. depending on location, frequency, and severity of interferers, these variations can correspond to the source of communication interferences. For example, a neighboring base station 102 which shares bandwidth with a subscriber unit of interest, can send electromagnetic waves that will act as unwanted signal or noise, causing changes in the SINR per subcarrier, even in the absence of a subscriber unit communicating with its target base station. Once collected as SCI by a base station site 101, these variations can be indicative of severity of interference, on per subcarrier basis. The statistical analysis module 1520 is configured to determine, based on the data regarding the spatial streams received during SCI procedures, if a subscriber unit 103 is affected by communication interferences from (a) a source within the set of subscriber units 103, such as another base station or subscriber unit, or (b) a source external to the set of subscriber units 103, such as other radio transmitters, etc.

In some embodiments, the statistical analysis module 1520 extracts the external interferences from those commonly associated with the other subscriber unit, to isolate and identify the source of the communication interference. The extraction can, for example, be performed by “listening to RF energy in the channels and/or directions of interest”, when no data is being transmitted, Then the SCI only includes interference effect, and other statistics like duty cycle and strength of interference can be recorded and then reported back to the base station. In another example, when the interference in subscriber unit co-exists with data transmission, historical channel information from base station to subscriber unit link, can be gathered and compared to historical data to see if there is any rise in the level of received signal. This rise can be attributed to the interference provided that it was not due to a power increase in the base station transmitter.

Next, in block 1620, the statistical analysis module 1520 generates a set of data 1525 (e.g. Data_1 to Data_n) based on parameters associated with the power of signals received at one end or another of a channel. The power-based data can be included in the received set of SCI 1515 to assist in characterizing spatial streams 1510. The set of power-based data is generated on a spatial stream basis and may include one or more of statistical parameters such as an average power, mean power, periodicity, or variance in power. In some embodiments, the statistical analysis module 1520 is configured to utilize analytic tools and procedures, such as machine learning to generate the set of power-based data.

Next, in some embodiments in block 1630, the statistical analysis module 1520 determines the location of a source of interference, the location of the affected base-station 102 and the location of at least one affected subscriber unit. In some embodiments, the statistical analysis module 1520 determines the location of the interference source using: (1) a time-based triangualtion technique, such as Time of Arrival (ToA), Time Difference of Arrival (TDoA); (2) an angle-based determination, such as Angle of Arrival (AoA); (3) a power-based determination technique, such as Returned Signal Strength Indicator (RSSI), or (4) a combination of one or more of the above or other techniques known in the art. In at least some embodiments, the information is attained from several sources (i.e., base stations and/or subscriber units 103) and used together to determine the location and nature of the interferer.

FIG. 17 illustrates an alternative embodiment to the communication device shown in FIG. 15, in that the reports are provided from subscriber units 103 that provide Air Quality Statistics 1710 in accordance with some embodiments of the present disclosure.

FIG. 18 is a flow diagram further illustrating another determination operation by the statistical analysis module 1520 of the embodiment shown in FIG. 17, and previously noted in block 1410. As shown in FIG. 18, in block 1810 the statistical analysis module 1520 statistically analyzes the received set of SCI reports 1715, such as channel state statistics (CSS), which may include, amongst others, information on other networks seen, air time occupancy etc. as well as information on (a) the strength of the beacon signal from each base station 102 (or Access Point in WiFi case), (b) the number of frames received during a specified time interval, the average signal strength from each sender, (c) Statistics such as average delay encountered while waiting to send, number of failed transmissions and number of FCS errors detected on received frames, (d) Statistics on a stream of frames, neighboring base stations, of information for preparing a subscriber unit 103 to transition to another base station 102.

The result of the above statistical analysis is a determination, such as based on a measured power of each subscriber units 103 at a frequency and/or time, as to whether a subscriber unit 103 is affected by communication interferences. The source of such interference may be from: (1) a source within the set of subscriber units 103, such as another subscriber unit, or (2) a source external to the set of subscriber units 103, such as other radio transmitters, trees, other buildings and obstacles, or natural phenomena such as inclement or stormy weather. In some embodiments, the received set of SCI reports 1715 includes a set of air quality statistics (AQS) 1710 information on communication channels. Each AQS (e.g. AQS_1 to AQS_n) corresponds to a subscriber unit 103 (e.g. subscriber unit_1 to subscriber unit_n). In some embodiments, AQS information may include those corresponding to a request from a base station to a particular one of the subscriber units 103. In some embodiments, a subscriber unit AQS may include, among other data, information on channel loading, noise histogram, provided location information, the status of the radio network interference levels (e.g. by using the noise histogram report) and network load statistics (e.g. by using the channel load report).

Next, in block 1820, the statistical analysis module 1520 generates a set of location-based data 1725 (e.g. Data_1 to Data_n) for the received one or more air quality statistics reports 1715. In some embodiments, the generated set of location-based data can establish an interference distribution map, such as one indicating how interference is distributed in different regions in terms of statistical and power data, for the communication channels corresponding to the subscriber units 103. In some embodiments, the statistical analysis module 1520 is configured to utilize analysis tools and procedures such as Principal Component Analysis (PCA) to remove the irrelevant statistics from the received sets 1710 and 1715, for generation of the set of location-based data 1725 and its interference distribution maps.

Next, in block 1830, the statistical analysis module 1520 determines the location of the interference source, the location of the affected base-station 102 and the location of at least one affected subscriber unit. In some embodiments, the statistical analysis module 1520 determines the location of the interference source using: (1) a time-based triangulation technique, such as Time of Arrival (ToA), Time Difference of Arrival (TDoA); (2) an angle-based determination, such as Angle of Arrival (AoA); (3) a power-based determination technique, such as Returned Signal Strength Indicator (RSSI); or (4) any combination of the above or other techniques known in the art. In at least some embodiments, the information is attained from several sources (i.e., base stations and/or subscriber units 103) and used together to determine the location and nature of the interferer. The source and location of communication interference between a base station and affected subscriber units 103 is determined from received SCI that are currently in use for other 802.11 purposes.

FIG. 19A is a flow diagram of an interference mitigating operation (as previously noted in block 1420) of the interference mitigation circuitry 1530 (FIGS. 15 and 17), which is performed based on the determination in block 1410.

FIG. 19B is a timing diagram illustrating the amount of interference over time as determined by the operation of FIG. 19A.

As shown in block 1930, the mitigation circuitry 1530 is configured to reschedule communication between the base station 102 and at least one affected subscriber unit, to a time at which interferences is estimated to be lower than at other possible times. For example, communication can be rescheduled to a time when the level of communication interferences is estimated to be less than a predetermined signal to noise ratio (SNR). Alternatively, the communication can be rescheduled to a time when the signal to interference plus noise ratio (SINR) is higher. In these cases, the “interference” corresponds to the communication interference from the interference source, as illustrated in FIG. 19B. In some embodiments, the rescheduling based on SCI feature includes sending predetermined sounding signals to a base station that senses distortions in the sounding signals. Upon sensing the distortion, the base station reschedules its next transmission to another time.

In the example shown in FIG. 19B, the interference level represented by line 1910 is determined to be greater than the predetermined SNR level 1920 during time period t₁. If t₁ is when the signal was originally scheduled to be transmitted, the interference mitigation circuitry 1530 reschedules the transmission to a time period t₂, which is known or estimated to have interference levels below the predetermined SNR level 1920. In one example, an external radio source may cause higher than acceptable interference levels during time period t₁. Accordingly, the transmission is rescheduled to time period t₂ when the external radio source has ceased its transmissions, or is expected to have ceased transmitting.

In some embodiments, the rescheduling can be determined by a Central Scheduler (such as Coordination and Control Center 604) which may reside in or communicates with Network Management 1540. In some such embodiments, the Network Management 1540 communicates with the statistical analysis module 1520 as shown in FIGS. 15 and 17.

FIG. 20A is a flow diagram of another interference mitigating operation (block 1420) of the interference mitigation circuitry 1530, which is performed based on the determination in block 1410. As shown in FIG. 20A, in block 2020, the mitigation circuitry 1530 is configured to reroute a communication between a base station 102 and at least one affected subscriber unit, to a different communication path between an affected base-station 102 and/or an affected subscriber unit 103. The different communication path includes at least one subscriber unit 103 unaffected by the source.

FIG. 20B is an illustration of the environment in which the operations disclosed in FIG. 20A may be performed. After the statistical analysis module 1520 determines that building 108 is the source of interference between the base station 102a and a subscriber unit 2010, the interference mitigation circuitry 1530 reroutes the communication, such as via beamforming techniques, to a different (or alternate) communication path. For example, in one case communication over the path 2001 that is blocked by the building 108 is re-routed to an alternative path 2002 to a subscriber unit 2011 that relays the signal over a path 2003. In this case, paths used for re-routing include a different base-station 102b and a relay subscriber unit 2011.

In some embodiments, the rerouting path can be determined by a Central Re-router (such as Coordination and Control Center 604 in FIG. 6) which may reside in, or communicates with, the Network Management 1540. The Network Management 1540 in turn communicates with the statistical analysis module 1520, as shown in FIGS. 15 and 17.

In some embodiments, SCI information is not only used for beamforming, but also to determine when interferences are likely to be present. A determination as to when to transmit or receive can be made based on when the channels are clear. For example, in case of 802.11ac waveform, data provided in a Multi-User Explicit Beamforming Report field can be used to determine the level of interference. That determination can then be used for interference mitigation. This field carries signal-to-noise ratio differences between subcarriers, which can also be used for updating the mitigation of the interference. As described above, based on the localization of the interference source, its statistical data (e.g. power, variance, periodicity, etc.) and location of base station sites and subscriber units, beamforming mechanism can be adjusted (e.g. in single user, and multiuser scenarios) to reduce the effects of the interference. This adjustment can be in coordination with the scheduler or re-route, so as to transmit to the subscriber units (or in the uplink from a subscriber unit to a base-station) whose link is not expected to be significantly affected by the interference.

It is to be understood that the foregoing description is intended to illustrate, and not to limit, the scope of the claimed invention. Accordingly, other embodiments are within the scope of the claims. Note that paragraph designations within claims are provided to make it easier to refer to such elements at other points in that or other claims. They do not, in themselves, indicate a particular required order to the elements. Further, such designations may be reused in other claims (including dependent claims) without creating a conflicting sequence.

The previous description is provided to enable any person skilled in the art to practice the various aspects described herein. Various modifications to these aspects will be readily apparent to those skilled in the art, and the generic principles defined herein may be applied to other aspects.

What is claimed is:

1. A method comprising:
receiving, in a base station, standards-based channel information (SCI) corresponding to at least one subscriber unit operating at radio frequencies in communication with the base station;
determining, from the received SCI, if communication between the base station and at least one subscriber unit is affected by interference; and
mitigating, based on the determining, the effect of the interference.

2. The method of claim 1, wherein mitigating includes rescheduling communication between the base station and at least one subscriber unit to a time at which interferences is estimated to be lower than at other possible times based on the determination.

3. The method of claim 1, wherein mitigating includes rerouting, based on the determination, a communication between the base station and at least one subscriber unit, to a different communication path between the base-station and the subscriber unit.

4. The method of claim 3, wherein the rerouting includes redirecting a beam corresponding to communication between the affected base-station and the subscriber unit to the different communication path.

5. The method of claim 3, wherein the determining includes determining locations of a source of the interference, the location of the base-station and the location of at least one affected subscriber unit.

6. The method of claim 5, wherein the determining the location of the source includes at least one of a time-based, a power-based or an angle-based determination.

7. The method of claim 5, wherein the different communication path includes at least one subscriber unit unaffected by the source.

8. The method of claim 1, wherein determining comprises analyzing statistically the received set of SCI.

9. The method of claim 8, wherein the statistical analysis is used to determine if a subscriber unit is affected by communication interferences from a source within or external to the set of subscriber units.

10. The method of claim 9, wherein the received set of SCI include MIMO beamforming reports in conformance with WiFi standards, and wherein the analyzing includes a statistical analysis of the received MIMO beamforming reports.

11. The method of claim 9, wherein the received SCI include air quality statistics on communication channels corresponding to one or more subscriber units in the set of subscriber units.

12. The method of claim 11, further comprising generating a set of location-based data for the received one or more air quality statistics on communication channels corresponding to the one or more subscriber units in the set of subscriber units.

13. The method of claim 12, wherein the generated set of location-based data includes an interference distribution map for the communication channels corresponding to the one or more subscriber units in the set of subscriber units.

14. The method of claim 9, wherein the received set of SCI characterize spatial streams corresponding to one or more subscriber units in the set of subscriber units.

15. The method of claim Error! Reference source not found., wherein the spatial stream may include data on variations per sub-carrier basis corresponding to one or more subscriber units, the variations corresponding to the source of communication interferences.

16. The method of claim 15, wherein the data on variations per sub-carrier basis may include differences in signal-to-noise (SNR) ratio or signal to interference plus noise ratio (SINR) between subcarriers.

17. The method of claim Error! Reference source not found., further comprising generating a set of power-based data for the characterized one or more spatial streams in the received set of SCI corresponding to the one or more subscriber units in the set of subscriber units.

18. The method of claim 17, wherein generated set of power-based data includes statistical parameters including at least one of an average power, mean power, periodicity, or variance in power.

19. A communication device, comprising:
a statistical analysis module configured to receive standards-based channel information (SCI) corresponding to at least one subscriber unit operating at radio frequencies in communication with the communication device, the statistical analysis module further configured to determine, from the received SCI, if communication between the base station and at least one subscriber unit is affected by interference; and
an interference mitigation circuitry configured to mitigate the effect of an interference determined by the statistical analysis module.

20. The communication device of claim 19, wherein the communication device is housed in at least of a base-station or a subscriber unit,
wherein the statistical analysis module is configured to determine locations of a source of the interference, the base-station and at least one affected subscriber unit, and
wherein the location of the source is determined based on at least one of a time-based, a power-based or an angle-based determination.

21. The communication device of claim 19, wherein the interference mitigation circuitry is configured to reschedule communication between the base station and at least one subscriber unit to a time at which interferences is estimated to be lower than at other possible times.

22. The communication device of claim 19,
wherein the interference mitigation circuitry is configured to reroute a communication between the base station and at least one subscriber unit, to a different communication path between the base-station and the subscriber unit, via a redirection of a beam corresponding to communication between the affected base-station and the subscriber unit to the different communication path; and
wherein the different communication path includes at least one subscriber unit unaffected by the source.

23. The communication device of claim 19,
wherein the statistical analysis module is configured to determine, based on the received set of SCI, if a subscriber unit is affected by communication interferences from a source within or external to the set of subscriber units, wherein the received set of SCI characterize spatial streams corresponding to one or more subscriber units in the set of subscriber units; and
wherein the spatial stream may include data on variations per sub-carrier basis corresponding to one or more subscriber units, the variations corresponding to the source of communication interferences.

24. The communication device of claim Error! Reference source not found.:
wherein the statistical analysis module configured to generate a set of power-based data for the characterized one or more spatial streams in the received set of SCI corresponding to the one or more subscriber units in the set of subscriber units, and
wherein generated set of power-based data includes statistical parameters including at least one of an average power, mean power, periodicity, or variance in power.

25. The communication device of claim 19;
wherein the received SCI include air quality statistics on communication channels corresponding to one or more subscriber units in the set of subscriber units;
wherein the statistical analysis module is configured to generate a set of location-based data for the received one or more air quality statistics on communication channels corresponding to the one or more subscriber units in the set of subscriber units; and
wherein the generated set of location-based data includes an interference distribution map for the communication channels corresponding to the one or more subscriber units in the set of subscriber units.
